(19) United States
(12) Patent Application Publication
(10) Pub. No.: US 2026/0253087 A1
(43) Pub. Date: Aug. 27, 2026

(54) METHOD AND SYSTEM FOR AUTOMATED COMPLIANCE VERIFICATION OF ARTIFICIAL INTELLIGENCE (AI) PROJECTS

(71) Applicant: LTI Mindtree Ltd, Mumbai (IN)

(72) Inventors: Aritra Sen, Mumbai (IN); Anindita Desarkar, Mumbai (IN); Vishwanathan Raman, Mumbai (IN); Pradeep Kumar, Mumbai (IN); Ashish Varerkar, Mumbai (IN)

(21) Appl. No.: 19/226,228

(22) Filed: Jun. 3, 2025

(30) Foreign Application Priority Data
Feb. 27, 2025 (IN) 202521017581

(51) Int. Cl. G06Q 30/018; G06F 21/62

(52) U.S. Cl. CPC G06Q 30/018; G06F 21/6227

(57) ABSTRACT

A method and system for automated compliance verification of AI projects is disclosed. The system maintains a hybrid knowledgebase comprising a vector store containing embedding vectors generated from a plurality of AI regulatory documents of multiple countries, and a graph database storing country-specific knowledge graphs. The system receives an input document corresponding to an AI project, and a user prompt specifying at least one country for compliance verification, and generates embedding vectors. The system leverages a rule engine to execute vector-based matching between embedding vectors of the input document and the vector store. The system then performs graph-based analysis using knowledge graphs to identify regulatory requirements applicable to the input document to evaluate compliance. A compliance report comprising a compliance status and remediation recommendations for non-compliant regulatory requirements is generated and provided to a user.

### FIELD

Various embodiments of the present disclosure relate to compliance verification. More particularly, the present disclose relates to a method and system for compliance verification of Artificial Intelligence (AI) projects using an automated plug and play framework with minimal or no human intervention.

### BACKGROUND

AI based projects and applications are rapidly increasing across the globe in recent times. AI technologies are being integrated into various industries, including healthcare, finance, manufacturing, transportation, and government services, revolutionizing traditional processes and enhancing efficiency. The growing adoption of AI is driven by advancements in machine learning, deep learning, and natural language processing, enabling systems to perform complex decision-making tasks with minimal human intervention.

With the increasing deployment of AI projects and applications, there is a rising need for compliance with regulatory frameworks to ensure ethical, legal, and secure use of AI technologies. Different countries have established distinct AI governance policies addressing concerns such as data privacy, algorithmic transparency, bias mitigation, and accountability. However, the absence of standardized global regulations presents challenges for organizations developing and deploying AI systems across multiple jurisdictions.

Many regulatory bodies are adopting a risk-based approach, particularly focusing on high-risk AI applications that have the potential to impact fundamental rights, safety, and social well-being. These high-risk applications often include AI systems used in areas such as healthcare diagnostics, financial decision-making, autonomous vehicles, recruitment processes, and law enforcement. To effectively manage the risks associated with such applications, regulatory frameworks emphasize continuous monitoring, explainability, and human oversight.

Alongside regulatory measures, ethical guidelines are gaining prominence, ensuring that AI systems align with fundamental principles such as fairness, transparency, and accountability. Ethical considerations play a crucial role in mitigating biases that could lead to discriminatory outcomes, enhancing public trust in AI technologies. Organizations and policymakers are increasingly recognizing the importance of incorporating fairness metrics, explainability tools, and accountability frameworks into AI development lifecycles to prevent unintended harm and ensure responsible AI deployment.

Moreover, several countries such as, United States, United Kingdom, Japan, Singapore, China etc. came up with AI regulations. While the US doesn't have a single, overarching AI Act, it has various regulations and guidelines related to AI, such as the AI Bill of Rights and the NIST AI Risk Management Framework. The UK has adopted a principles-based approach to AI regulation, focusing on safety, security, fairness, transparency, and accountability. Japan has established the “Social Principles of Human-Centered AI,” emphasizing ethical considerations and human values in AI development. Singapore has a Model AI Governance Framework that provides guidelines for responsible AI development and deployment. China has implemented the “Interim Measures for the Administration of Generative Artificial Intelligence Services,” which aims to regulate generative AI services. Despite coming up with various aforementioned AI regulations individually, there are concerns that are unaddressed such as, lack of centralized AI act and regulations system.

Additionally, several industry players have developed various solutions for AI compliance verification, relying on manual checking, traditional NLP-based methods, and rule-based compliance checking. However, each of these approaches has significant limitations. Manual checking is not only time-consuming but also prone to human errors and subjective evaluations, making it inefficient for large-scale compliance assessments. Traditional NLP-based compliance checking often falls short, as it struggles to understand regulatory nuances and lacks contextual awareness, leading to inaccurate or incomplete evaluations. Rule-based compliance checking, while structured, depends heavily on predefined rules provided by the user, making it inflexible and incapable of dynamically identifying regulatory requirements based on an AI system's specific attributes. As a result, existing methods fail to offer scalable, accurate, and adaptive compliance verification in the rapidly evolving regulatory landscape governing AI systems.

Despite addressing and coming up with different AI regulations as mentioned above, there are significant issues that are unaddressed such as, lack of centralized AI act and regulations system, lack of guided framework which can help users to extract AI law related information, lack of framework for AI laws compliance checks on a given document. Unavailability of generic framework with above requirements is burning lack in the space of AI systems.

Therefore, there is a need for a method and system that can effectively address the aforementioned challenges in an automated fashion with no or minimal human intervention.

### SUMMARY

The present disclosure provides a method and system for automated compliance verification of AI projects. The system maintains a hybrid knowledgebase comprising a vector store containing embedding vectors generated from a plurality of AI regulatory documents corresponding to a plurality of countries, and a graph database storing country-specific knowledge graphs. Each knowledge graph represents relationships between AI regulatory requirements for a corresponding country. The system receives an input document corresponding to an AI project, and a user prompt specifying at least one country for compliance verification, and generates embedding vectors for the input document. The system generates at least one compliance verification prompt based on the vector-based matching and graph-based analysis, and presents the at least one compliance verification prompt to a user for selection, and executes compliance verification using a selected compliance verification prompt. The system leverages a rule engine to execute vector-based matching between embedding vectors of the input document and the vector store. The system then performs graph-based analysis using knowledge graphs corresponding to the at least one country to identify regulatory requirements applicable to the input document to evaluate compliance of the input document with respect to the identified regulatory requirements. A compliance report comprising a compliance status and remediation recommendations for non-compliant regulatory requirements is generated and provided to a user.

### BRIEF DESCRIPTION OF THE FIGURES

FIG. 1 is a diagram that illustrates an exemplary embodiment within which various embodiment of the disclosure may function.

FIG. 2 is a diagram that illustrates a system for automated compliance verification of AI projects, in accordance with an embodiment of the present disclosure.

FIG. 3 is a diagram that illustrates steps for the creation of hybrid knowledgebase for compliance verification, in accordance with an embodiment of the disclosure.

FIG. 4 is a diagram that illustrates a flowchart for a method for automated compliance verification of AI projects, in accordance with an embodiment of the present disclosure.

### DETAILED DESCRIPTION

Pursuant to various embodiment, the present disclosure provides a method and system for automated compliance verification of AI projects. The system maintains a hybrid knowledgebase comprising a vector store containing embedding vectors generated from a plurality of AI regulatory documents corresponding to a plurality of countries, and a graph database storing country-specific knowledge graphs. Each knowledge graph represents relationships between AI regulatory requirements for a corresponding country. The system receives an input document corresponding to an AI project, and a user prompt specifying at least one country for compliance verification, and generates embedding vectors for the input document. The system generates at least one compliance verification prompt based on the vector-based matching and graph-based analysis, and presents the at least one compliance verification prompt to a user for selection, and executes compliance verification using a selected compliance verification prompt. The system leverages a rule engine to execute vector-based matching between embedding vectors of the input document and the vector store. The system then performs graph-based analysis using knowledge graphs corresponding to the at least one country to identify regulatory requirements applicable to the input document to evaluate compliance of the input document with respect to the identified regulatory requirements. A compliance report comprising a compliance status and remediation recommendations for non-compliant regulatory requirements is generated and provided to a user.

In one or more embodiments, AI compliance verification refers to the process of systematically assessing AI projects against relevant regulatory requirements, ethical guidelines, and legal frameworks to ensure adherence to jurisdiction-specific compliance standards. This involves evaluating various aspects of AI systems, including data privacy, bias mitigation, explainability, security, and accountability, based on the specific laws and policies governing AI in different countries.

In one or more embodiments, a knowledge base refers to a structured repository that stores and organizes regulatory information, compliance rules, and domain-specific knowledge related to AI governance across different jurisdictions. The knowledge base serves as the foundation for automated compliance verification by enabling efficient retrieval, comparison, and analysis of AI regulatory requirements applicable to various countries.

In one or more embodiments, a graph database storing country-specific knowledge graphs refers to a structured data repository designed to model, store, and analyze the relationships between AI regulatory requirements specific to different countries. The graph database represents regulatory requirements as interconnected entities, enabling semantic understanding and contextual reasoning of AI compliance rules.

### Each Country-specific Knowledge Graph Within the Graph Database Captures the

hierarchical structure, dependencies, and interconnections among various AI regulations, policies, and governance principles applicable to that country. The knowledge graphs comprise nodes representing regulatory elements such as laws, guidelines, ethical principles, compliance requirements, and enforcement mechanisms, edges representing relationships between these elements, such as dependencies (e.g., a high-risk AI category requiring human oversight), conditional requirements (e.g., GDPR mandates additional data protection measures for AI handling sensitive data), or exemptions, and attributes representing metadata associated with nodes and edges, such as the effective date of a regulation, its jurisdiction, risk classification, and applicability criteria.

In one or more embodiments, embedding vectors refer to numerical representations of textual data, generated using machine learning techniques such as word embeddings, sentence embeddings, or document embeddings. The embedding vectors capture the semantic meaning and contextual relationships of words, phrases, or entire regulatory documents, enabling efficient similarity-based comparisons between AI project documentation and regulatory texts.

In one or more embodiments, AI regulatory documents refer to a collection of laws, policies, guidelines, and standards established by governments, regulatory bodies, and international organizations to govern the development, deployment, and usage of artificial intelligence systems. The documents define compliance requirements, risk classifications, ethical considerations, and enforcement mechanisms to ensure AI technologies are used responsibly, transparently, and in alignment with societal values.

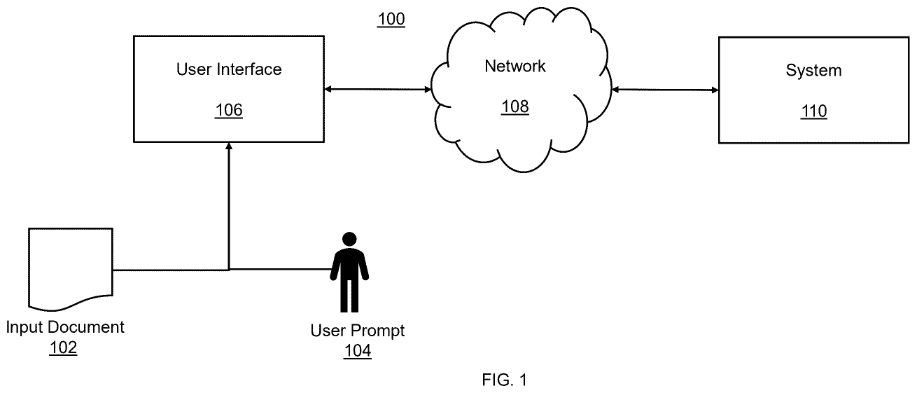

FIG. 1 is a diagram that illustrates an exemplary environment 100 within which various embodiments of the present disclosure may function. Referring to FIG. 1, the environment 100 comprises an input document 102, a user prompt 104, a user interface 106, a network 108, and a system 110.

The input document 102 provided to the system 110 via the user interface 106 refers to a document that describes various aspects of an AI project, serving as the primary artifact for compliance verification. The input document 102 may comprise a wide range of AI-related information, including but not limited to technical specifications, model architectures, data usage policies, training methodologies, risk assessments, and governance frameworks.

The input document 102 can take multiple forms, such as structured reports, unstructured textual descriptions, regulatory filings, or AI ethics assessments, depending on the nature of the AI project and the compliance requirements of a specific jurisdiction. The input document 102 may be submitted in various formats, including plain text, PDFs, spreadsheets, or machine-readable formats like JSON or XML.

The user prompt 104 provided to the system 110 via the user interface 106 refers to an input that allows a user to specify at least one country or jurisdiction for compliance verification. The user prompt 104 enables users to tailor the compliance assessment process based on the specific regulatory environment applicable to their AI project. The user prompt 104 may be provided in various forms, including a dropdown selection of countries or regions where compliance verification is required, a text input field allowing users to specify one or more country names manually, and an API request parameter where automated systems can specify target jurisdictions programmatically.

In one or more embodiments, the user prompt 104 comprises a selection of specific portions of the input document 102 for compliance verification, enabling a targeted and efficient assessment of AI regulatory requirements. Instead of analyzing the entire document, the user can specify particular sections, clauses, or components that require compliance verification, ensuring a granular and focused evaluation.

In an exemplary embodiment, the user prompt 104 may allow selection in various ways, such as,
Manual text selection within the user interface 106, where the user highlights relevant portions of the input document 102.
Predefined document sections.
Keyword-based filtering, where the user specifies regulatory themes or concerns (e.g., “GDPR compliance,” “AI fairness,” “automated decision-making accountability”).
Automated suggestions, where the system 110 identifies critical compliance-related sections and presents them to the user for selection.

In one or more embodiments, the system 110 extracts entities from the input document 102 and identifies related entities from the knowledge graphs corresponding to the at least one country specified in the user prompt 104.

In one or more embodiments, the entity extraction process involves analyzing the input document 102 to identify key elements relevant to AI compliance, such as data processing methods, AI model types, risk classifications, data privacy measures, and governance frameworks. The extracted entities are then mapped to corresponding regulatory requirements stored in the knowledge graphs of the selected country.

The user interface 106 refers to the interactive component that facilitates communication between the user and the system 110, enabling seamless submission of input data and retrieval of compliance verification results. The user interface 106 serves as a central access point for users to provide an input document 102, specify compliance verification parameters through the user prompt 104, and receive a compliance report detailing regulatory adherence and remediation recommendations.

In an exemplary embodiment, the user interface 106 may be implemented in various forms such as, a dashboard, a command-line interface (CLI), an API based interface and a chatbot.

In one or more embodiments, the user interface 106, in addition to receiving the user prompt 104, is also configured to present the output generated by the system 110 to the user in an interactive and accessible manner. The user interface 106 may present the output in various formats, such as, but not limited to, compliance reports, visual dashboards, detailed regulatory mapping, actionable recommendations, interactive Q&A panel, and downloadable reports.

The network 108 facilitates communication between the various components of the environment 100, including the user interface 106, and the system 110. It enables the transfer of data, instructions, and results between the different modules and the user interface 106, allowing for seamless compliance verification of AI projects. The network 108 may comprise various communication protocols, such as local area networks (LAN), wide area networks (WAN), or the internet.

The system 110 is an end-to-end compliance verification framework designed to automatically assess AI projects and applications against global and country-specific AI regulations with minimal or no human intervention. By acting as a centralized compliance assessment engine, the system 110 ensures that AI projects adhere to regulatory frameworks that promote trustworthy, safe, and ethical AI development while simultaneously fostering innovation across industries.

In one or more embodiments, the system 110 operates in a unified plug-and-play format, making it adaptable to diverse regulatory environments and document types. The system 110 can process different formats of input documents, such as policy reports, technical documentation, data protection impact assessments, and system design specifications. The system 110 is scalable to support compliance verification against multiple AI regulatory frameworks, including country-specific AI Acts, GDPR-based AI compliance guidelines, and industry-specific AI governance policies.

The system 110 is also designed to function as a regulatory knowledge hub, leveraging a hybrid knowledgebase that supports Question & Answer (Q&A) capabilities. This allows the user to interact with the system 110 to retrieve country-specific AI regulatory information, clarify compliance requirements, and explore regulatory nuances applicable to AI projects operating across different jurisdictions.

Additionally, in one or more embodiments, the system 110 enhances the user prompt 104 to improve the retrieval of AI laws and compliance information. It applies Natural Language Processing (NLP) techniques to refine user queries, ensuring more accurate and context-aware regulatory insights. Furthermore, for the input document 102, the system 110 utilizes graph databases and a rule engine to automatically generate compliance verification prompts. By dynamically identifying key regulatory checkpoints, the system 110 optimizes the compliance evaluation process, reducing manual effort while ensuring comprehensive, accurate, and efficient regulatory assessments.

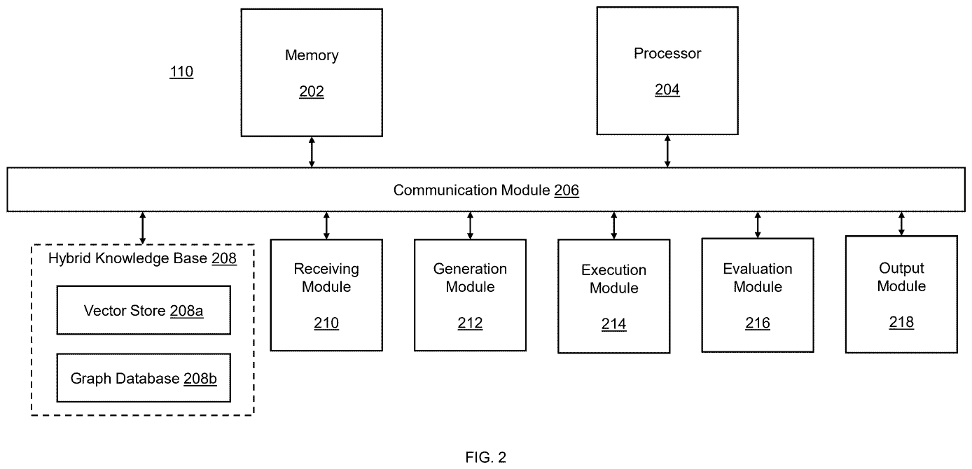

FIG. 2 is a diagram that illustrates the system 110 for automated compliance verification of AI projects, in accordance with an embodiment of the present disclosure. Referring to FIG. 2, the system 110 comprises a memory 202, a processor 204, a communication module 206, a hybrid knowledgebase 208 comprising a vector store 208a and a graph database 208b, a receiving module 210, a generation module 212, an execution module 214, an evaluation module 216, and an output module 218.

The memory 202 may comprise suitable logic, code, and/or interfaces that may be configured to store instructions (for example, computer-readable program code) that can implement various aspects of the present disclosure.

The processor 204 may comprise suitable logic, code, and/or interfaces that may be configured to execute the instructions stored in the memory 202 to implement various functionalities of the system 110 in accordance with various aspects of the present disclosure. The communication module 206 is configured to facilitate seamless interaction between the processor 204 and various modules within the system 110.

The hybrid knowledgebase 208 refers to a structured data repository that integrates multiple sources of regulatory information to support automated compliance verification of AI projects. It combines different data storage and retrieval techniques to ensure efficient processing and accurate interpretation of AI regulations across various jurisdictions. The hybrid knowledgebase 208 is designed to handle both structured and unstructured data, enabling the system 110 to efficiently analyze AI regulatory documents and compare them against AI project documents for compliance assessment.

In one or more embodiments, the hybrid knowledgebase 208 consists of two key components: the vector store 208a and the graph database 208b. The vector store 208a facilitates efficient comparison between AI regulatory documents and project-specific documents by leveraging advanced similarity-based retrieval methods. The graph database 208b, on the other hand, represents AI regulatory frameworks in a structured format, capturing relationships between different regulatory requirements, clauses, and country-specific compliance rules.

In one or more embodiments, the hybrid knowledgebase 208 is updated by incorporating new regulatory requirements and relationships derived from updated AI regulatory documents, so as to make the system 110 remain aligned with evolving AI governance frameworks, compliance mandates, and ethical guidelines across different jurisdictions.

The update process involves extracting new AI regulations, amendments, or policy changes from authoritative sources such as government publications, regulatory bodies, industry guidelines, and international AI governance frameworks. The vector store 208a is updated by generating new embedding vectors for the revised regulatory text, while the graph database 208b is enriched with new nodes and edges representing newly introduced compliance requirements and their interdependencies with existing regulations.

In some non-limiting embodiments, the hybrid knowledgebase 208 is updated continuously or periodically to ensure that the system 110 maintains an accurate and up-to-date representation of AI regulatory requirements across different jurisdictions. The update frequency may depend on factors such as the rate of regulatory changes, the availability of new AI compliance documents, and the specific needs of the users or organizations utilizing the system 110.

In continuous updating, the system 110 automatically monitors regulatory sources, identifies changes, and integrates new compliance rules into the vector store 208a and the graph database 208b in real time. Continuous updates are particularly useful for industries and applications where AI regulations evolve rapidly, such as finance, healthcare, and autonomous systems.

In periodic updating, the system 110 follows a scheduled update cycle, where regulatory changes are aggregated, reviewed, and incorporated at defined intervals (e.g., daily, weekly, or monthly). This approach helps balance computational efficiency and regulatory accuracy, particularly in cases where real-time updates may not be necessary. Periodic updates may involve manual verification processes, allowing experts to validate changes before integrating them into the system 110.

The vector store 208a stores embedding vectors generated from AI regulatory documents across multiple jurisdictions. By converting text-based regulations into numerical representations, the vector store 208a allows for semantic similarity matching between AI project documents and legal requirements.

In one or more embodiments, embedding vectors in the vector store 208a are generated through a multi-step process designed to facilitate efficient retrieval and comparison of AI regulatory requirements. The process begins by segmenting a collection of AI regulatory documents into smaller, meaningful text chunks, which enables each portion of the document, such as individual clauses, provisions, or guidelines, to be processed independently while maintaining contextual relevance.

Once the text chunks are created, each chunk is converted into a numerical representation known as an embedding vector. This transformation is performed using NLP models, such as deep learning-based sentence embedding techniques, which captures the semantic meaning of the text rather than relying on exact word matching. The embedding vectors encode the relationships and nuances of regulatory language, allowing for more accurate and context-aware comparisons between AI project documents and compliance requirements.

After the embedding vectors are generated, they are stored in the vector store 208a alongside metadata. The metadata typically includes details such as document source, country of origin, section number, and topic classification (e.g., privacy, accountability, bias mitigation). This structured storage approach enables efficient retrieval of relevant regulatory information based on similarity searches, allowing the system 110 to identify the most applicable compliance requirements for an AI project.

The graph database 208b organizes AI regulations in a graph-based structure, where nodes represent regulatory requirements, and edges define relationships between them. Each country has a specific knowledge graph that maps out its AI laws, including dependencies between clauses, risk categories, and obligations for different AI applications.

In one or more embodiments, the knowledge graph for each country is a structured representation of AI regulatory requirements, designed to capture the complex relationships between different legal provisions. Each knowledge graph is composed of the nodes and the edges.

In one or more embodiments, the nodes represent individual regulatory requirements within AI compliance framework of a specific country. The nodes may correspond to specific obligations, prohibitions, guidelines, or best practices outlined in AI laws, policies, or ethical guidelines. For example, a node could represent a requirement for transparency in AI decision-making, bias mitigation in machine learning models, or data privacy protection in AI systems.

In one or more embodiments, the edges define the relationships between these regulatory requirements, illustrating how different provisions interact or depend on one another. The relationships can include logical dependencies (e.g., “Requirement A must be fulfilled before Requirement B”), hierarchical structures (e.g., “General AI governance principles link to more specific requirements on data usage”), or cross-references (e.g., “Compliance with data privacy laws is linked to user consent requirements”).

The receiving module 210 may comprise suitable logic, code, and/or interfaces that are configured to receive the input document 102 corresponding to an AI project along with the user prompt 104 specifying at least one country for compliance verification.

In one or more embodiments, the receiving module 210 enables seamless ingestion of AI project-related documents, which may include technical specifications, system architectures, data processing workflows, algorithm descriptions, model training details, governance policies, and risk assessments. The receiving module 210 analyzes the received input document 102 to determine that it is properly formatted and pre-processed for further analysis.

Additionally, the receiving module 210 processes the user prompt 104, which may specify a single country or multiple jurisdictions for compliance verification, which makes the system 110 to dynamically adjust its compliance analysis based on the selected regulatory framework(s). The receiving module 210 may also support additional user preferences, such as selecting specific sections of the document for verification, specifying a compliance threshold, or requesting detailed explanations of regulatory requirements.

In one or more embodiments, the receiving module 210 is further configured to generate at least one compliance verification prompt based on the results of vector-based matching and graph-based analysis. The compliance verification prompts are dynamically created to highlight specific regulatory aspects relevant to the AI project, ensuring that compliance verification is targeted and contextually relevant.

The receiving module 210 presents the compliance verification prompt(s) to the user via the user interface 106, allowing the user to review and select the most appropriate prompt for further compliance evaluation. This interactive selection process ensures that the compliance verification aligns with the user's intent, regulatory priorities, or specific concerns related to the AI project.

In one or more embodiments, once a compliance verification prompt is selected, the receiving module 210 executes the compliance verification process using the selected prompt, leveraging knowledge graphs and regulatory embeddings for a more precise assessment.

In one or more embodiments, the receiving module 210 is configured to generate a compliance verification prompt using a combination of vector-based matching, graph-based analysis, and Retrieval-Augmented Generation (RAG) techniques. The vector-based matching identifies semantically relevant sections of the input document 102 by comparing its embedding vectors with those stored in the vector store 208a. The graph-based analysis further refines the compliance verification process by leveraging relationships between regulatory requirements stored in the graph database 208b. Additionally, RAG techniques enhance the prompt generation by dynamically retrieving and incorporating relevant regulatory knowledge, ensuring that the generated compliance verification prompts are contextually accurate and aligned with country-specific AI laws.

The generation module 212 may comprise suitable logic, code, and/or interfaces that are configured to generate embedding vectors for the input document 102.

In one or more embodiments, the generation module 212 processes the input document 102 by segmenting it into multiple text chunks to facilitate efficient representation and retrieval of relevant regulatory information. Each text chunk is then converted into embedding vectors using NLP techniques, such as transformer-based models, word embeddings, or sentence embeddings. The embeddings serve as a mathematical representation of the document's textual content, preserving semantic meaning and contextual relationships between different sections.

The generation module 212 confirms that the embedding vectors accurately capture the regulatory context, technical descriptions, and compliance-related assertions within the input document 102. The generated vectors are then stored in the vector store 208a, along with corresponding metadata, such as document section references, timestamps, and user-defined tags.

The execution module 214 may comprise suitable logic, code, and/or interfaces configured to execute vector-based matching between the embedding vectors of the input document 102 and those stored in the vector store 208a.

In one or more embodiments, the execution module 214 retrieves the embedding vectors of the input document 102 and compares them with the stored vectors in the vector store 208a to identify semantically similar regulatory provisions. This vector-based matching allows the system 110 to efficiently locate relevant sections of AI regulatory documents that are most applicable to the input document 102. The similarity scoring mechanism used for this matching may leverage techniques such as cosine similarity, Euclidean distance, or other advanced similarity metrics to determine regulatory clauses that closely align with the content of the AI project document.

Once the vector-based matching is complete, the execution module 214 proceeds with graph-based analysis using the graph database 208b corresponding to the at least one country specified in the user prompt 104. The execution module 214 traverses the nodes and edges of the country-specific knowledge graph to understand how different regulatory requirements relate to one another. By leveraging graph traversal algorithms, the system 110 identifies dependent, overlapping, or conflicting regulatory provisions and determines their relevance to the input document 102.

In one or more embodiments, the system 110 is configured to generate relevant question with associated reasoning, based on the identified regulatory requirements applicable to the input document 102.

In one or more embodiments, each generated question is accompanied by reasoning that explains why the question is necessary in the context of the selected laws. For instance, the reasoning may include references to specific legal provisions, regulatory principles, or compliance obligations that justify the need for verification. The system 110 then presents the generated questions to the user, allowing them to select specific questions for executing the compliance check.

In one or more embodiments, at least one compliance verification prompt is generated based on vector-based matching and graph-based analysis, and present the at least one compliance verification prompt to a user for selection. The compliance verification prompts are dynamically created to highlight specific regulatory aspects relevant to the AI project, ensuring that compliance verification is targeted and contextually relevant.

In one or more embodiments, the compliance verification prompt is presented to the user via the user interface 106, allowing the user to review and select the most appropriate prompt for further compliance evaluation. This interactive selection process ensures that the compliance verification aligns with the user's intent, regulatory priorities, or specific concerns related to the AI project.

In one or more embodiments, once selected the compliance verification prompt executed by leveraging knowledge graphs and regulatory embeddings for a more precise assessment.

The evaluation module 216 may comprise suitable logic, code, and/or interfaces configured to evaluate the compliance of the input document 102 with respect to the identified regulatory requirements. This evaluation is based on both vector-based matching results and graph-based analysis executed by the execution module 214.

In one or more embodiments, evaluating the compliance includes generating requirement-specific compliance scores for each regulatory requirement identified as applicable to the AI project. The evaluation module 216 assesses the alignment between the AI project document and each regulatory requirement by analyzing relevant clauses, their completeness, and any gaps in compliance. The requirement-specific compliance scores may be computed based on semantic similarity, rule-based evaluation, and contextual relevance between the AI project's descriptions and the corresponding regulations.

Furthermore, the evaluation module 216 calculates an overall compliance score for the AI project by aggregating the requirement-specific scores. The overall score may be weighted based on risk levels associated with different regulatory provisions, ensuring that high-risk AI regulations contribute more significantly to the final score.

In one or more embodiments, the evaluation module 216 is configured to calculate compliance scores based on a novel prompt-driven approach utilizing LLM-based reasoning. The compliance assessment involves determining the adherence percentage of the input document 102 to the identified regulatory requirements. Specifically, the evaluation module 216 analyzes various attributes, including the specific regulatory points adhered to and their respective adherence percentages. The entire scoring process leverages LLM-based reasoning, ensuring a more contextual and intelligent evaluation of compliance.

In one or more embodiments, the evaluation module 216 implements a rule engine to identify country-specific laws and regulatory requirements applicable to the input document 102. Once the relevant regulations are identified, the evaluation module 216 utilizes a question generator with reasoning to formulate a set of contextually relevant questions that assess the document's compliance with the identified laws. The generated questions serve as compliance checkpoints, ensuring a structured and thorough verification process.

The system 110 then presents the generated list of questions to the user, allowing them to select specific questions for a targeted compliance check. The selected question, referred to as the “User Selected Question,” is then used by the system 110 to perform a compliance evaluation, ensuring that the assessment aligns with the user's specific requirements.

The output module 218 may comprise suitable logic, code, and/or interfaces that are configured to generate and present a compliance report summarizing the compliance status of the input document 102 with respect to the identified regulatory requirements. The compliance report provides a structured overview, categorizing the regulatory requirements as compliant, non-compliant, or partially compliant, and includes explanations for each categorization.

In one or more embodiments, the remediation recommendations generated by the output module 218 include specific and actionable modifications to address non-compliant regulatory requirements. The recommendations may involve adjustments in policies, documentation refinements, or technical changes necessary for alignment with applicable AI regulations.

In one or more embodiments, the output module 218 is configured to generate recommendations for non-compliant regulatory requirements, along with an overall compliance health score. The recommendations provide specific actions required to achieve compliance, ensuring that the input document 102 aligns with the identified country-specific AI laws.

In one or more embodiments, the recommendations are prioritized based on the compliance health score and the severity of non-compliance, enabling users to focus on the most critical issues first. Additionally, advanced RAG techniques and reasoning models may be leveraged to further enhance the accuracy and contextual relevance of the recommendations, providing deeper insights into compliance gaps and the necessary corrective measures.

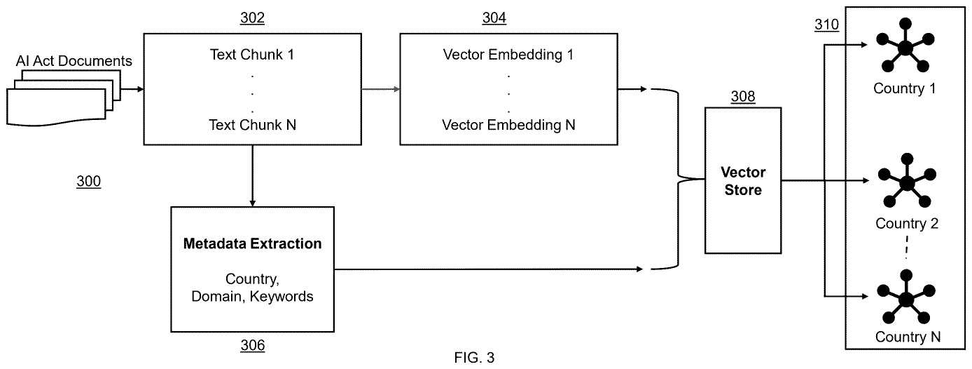

FIG. 3 is a diagram 300 that illustrates steps for creation of hybrid knowledgebase 208 for compliance verification, in accordance with an embodiment of the disclosure.

At 302, text chunking is performed on AI act documents that are received. The input AI act documents are segmented into multiple text chunks (Text Chunk 1 . . . Text Chunk N) to facilitate efficient processing. This segmentation ensures that each chunk represents a meaningful unit of information that can be processed independently while preserving contextual relevance.

At 304, vector embeddings are generated for the text chunks obtained from 302. Each text chunk is converted into a numerical representation, known as a vector embedding (Vector Embedding 1 . . . Vector Embedding N). This transformation enables semantic similarity comparisons between regulatory text and AI project documents, allowing the system 110 to identify relevant regulatory requirements efficiently.

At 306, metadata extraction is performed on the text chunks. Metadata refers to additional contextual information extracted from the text, such as country, document source, keywords, publication date, regulatory category, jurisdiction, and applicable AI compliance domains. This metadata enhances the system's 110 ability to retrieve and categorize relevant regulatory requirements.

At 308, the vector store 208a is created, combining the vector embeddings generated in 304 with the metadata information obtained in 306. The vector store 208a acts as a structured repository where embedding vectors are indexed along with their corresponding metadata. This enables efficient similarity searches and retrieval of regulatory information relevant to compliance verification.

At 310, a country-specific (Country 1, Country 2 . . . Country N) hybrid knowledgebase 208 is created from the vector store 208a. The knowledgebase integrates regulatory embeddings stored in the vector store 208a with structured representations of country-specific AI regulatory frameworks, including knowledge graphs that capture relationships between regulatory requirements. The hybrid knowledgebase 208 serves as the foundation for the automated compliance verification process, enabling the system 110 to dynamically assess AI project documents against evolving regulatory landscapes across multiple jurisdictions.

### Exemplary Embodiment

Consider an Artificial Intelligence (AI) development company that creates a Facial Recognition System (FRS) for public surveillance. The company wants to deploy its FRS in Germany and must ensure compliance with the EU Artificial Intelligence Act (EU AI Act) and General Data Protection Regulation (GDPR) before deployment.

A compliance officer uploads an input document detailing the technical specifications, data handling practices, and intended use of the FRS through the user interface 106. The input document includes:
Data collection process (e.g., real-time facial image capture)
Biometric data storage and retention policy
AI model training methodology
Risk mitigation strategies for bias and fairness
Security and encryption mechanisms

Additionally, the compliance officer provides a user prompt, specifying Germany as the country for compliance verification.

The receiving module 210 processes the input document and user prompt. It identifies key aspects of the input document related to compliance verification and forwards them for further analysis.

The generation module 212 segments the input document into text chunks and generates vector embeddings for each chunk. The vector embeddings are stored in the vector store 208a alongside metadata (e.g., document section, data type).

Simultaneously, the system 110 queries the graph database 208b, retrieving nodes and edges representing Germany's AI regulatory framework, including:
EU AI Act regulations on high-risk AI systems
GDPR requirements for biometric data processing
German Federal Data Protection Act (BDSG)

The execution module 214 performs vector-based matching between the embeddings of the input document and the stored regulatory embeddings. It also executes graph-based analysis to identify relevant compliance requirements applicable to the document.

The evaluation module 216 assesses the compliance with Germany's AI regulations. It generates:
Requirement-specific compliance scores for each regulatory requirement (e.g., GDPR Article 9 on biometric data processing).
Overall compliance score, reflecting the adherence to AI laws.

If non-compliance is detected, the evaluation module 216 flags issues such as:
Lack of explicit user consent for biometric data collection
Inadequate bias mitigation in facial recognition models
Absence of risk assessment and human oversight mechanisms

The output module 218 generates a compliance report summarizing:
Compliance status (e.g., “Partially Compliant”)
Regulatory violations (e.g., “Failure to implement human oversight as required by Article 14 of the EU AI Act”)
Remediation recommendations, such as:
   Implementing explicit opt-in consent for biometric data
   Conducting bias audits and publishing fairness reports
   Establishing a human-in-the-loop decision-making process

The compliance officer receives the report via the user interface 106 and can refine the AI act documents accordingly.

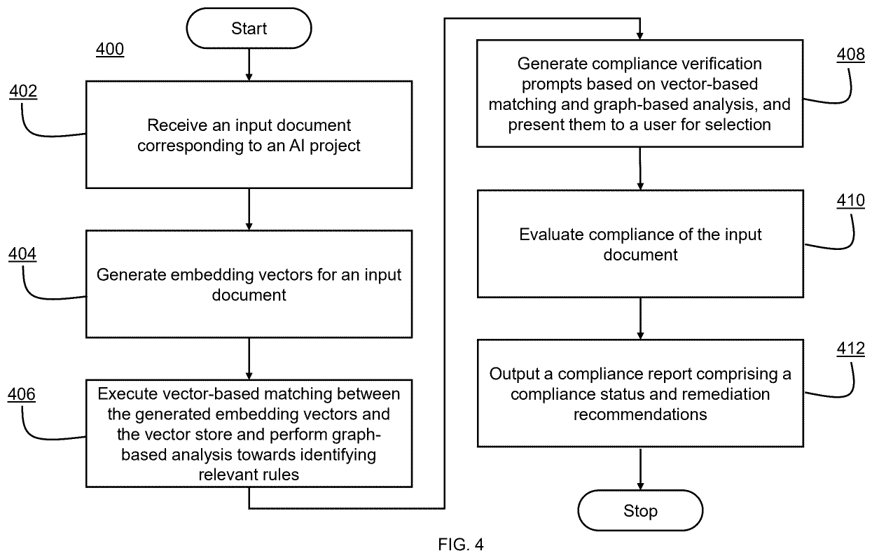

FIG. 4 is a diagram that illustrates a flowchart 400 for a method for automated compliance verification of AI projects, in accordance with an embodiment of the present disclosure.

At 402, an input document 102 corresponding to an AI project along with a user prompt 104 specifying at least one country for compliance verification is received by the receiving module 210.

In one or more embodiments, the receiving module 210 enables seamless ingestion of AI project-related documents, which may include technical specifications, system architectures, data processing workflows, algorithm descriptions, model training details, governance policies, and risk assessments. The receiving module 210 analyzes the received input document 102 to determine that it is properly formatted and pre-processed for further analysis.

Additionally, the receiving module 210 processes the user prompt 104, which may specify a single country or multiple jurisdictions for compliance verification, which makes the system 110 to dynamically adjust its compliance analysis based on the selected regulatory framework(s). The receiving module 210 may also support additional user preferences, such as selecting specific sections of the document for verification, specifying a compliance threshold, or requesting detailed explanations of regulatory requirements.

In one or more embodiments, the receiving module 210 is further configured to generate at least one compliance verification prompt based on the results of vector-based matching and graph-based analysis. The compliance verification prompts are dynamically created to highlight specific regulatory aspects relevant to the AI project, ensuring that compliance verification is targeted and contextually relevant.

The receiving module 210 presents the compliance verification prompt(s) to the user via the user interface 106, allowing the user to review and select the most appropriate prompt for further compliance evaluation. This interactive selection process ensures that the compliance verification aligns with the user's intent, regulatory priorities, or specific concerns related to the AI project.

In one or more embodiments, once a compliance verification prompt is selected, the receiving module 210 executes the compliance verification process using the selected prompt, leveraging knowledge graphs and regulatory embeddings for a more precise assessment.

In one or more embodiments, the receiving module 210 is configured to generate a compliance verification prompt using a combination of vector-based matching, graph-based analysis, and Retrieval-Augmented Generation (RAG) techniques. The vector-based matching identifies semantically relevant sections of the input document 102 by comparing its embedding vectors with those stored in the vector store 208a. The graph-based analysis further refines the compliance verification process by leveraging relationships between regulatory requirements stored in the graph database 208b. Additionally, RAG techniques enhance the prompt generation by dynamically retrieving and incorporating relevant regulatory knowledge, ensuring that the generated compliance verification prompts are contextually accurate and aligned with country-specific AI laws.

At 404, the generation module 212 generates embedding vectors for the input document 102.

In one or more embodiments, the generation module 212 processes the input document 102 by segmenting it into multiple text chunks to facilitate efficient representation and retrieval of relevant regulatory information. Each text chunk is then converted into embedding vectors using NLP techniques, such as transformer-based models, word embeddings, or sentence embeddings. The embeddings serve as a mathematical representation of the document's textual content, preserving semantic meaning and contextual relationships between different sections.

The generation module 212 confirms that the embedding vectors accurately capture the regulatory context, technical descriptions, and compliance-related assertions within the input document 102. The generated vectors are then stored in the vector store 208a, along with corresponding metadata, such as document section references, timestamps, and user-defined tags.

At 406, the execution module 214 executes vector-based matching between the generated embedding vectors and the vector store, and graph-based analysis using knowledge graphs corresponding to the at least one country to identify relevant rules, regulatory requirements applicable to the input document 102.

In one or more embodiments, the execution module 214 retrieves the embedding vectors of the input document 102 and compares them with the stored vectors in the vector store 208a to identify semantically similar regulatory provisions. This vector-based matching allows the system 110 to efficiently locate relevant sections of AI regulatory documents that are most applicable to the input document 102. The similarity scoring mechanism used for this matching may leverage techniques such as cosine similarity, Euclidean distance, or other advanced similarity metrics to determine regulatory clauses that closely align with the content of the AI project document.

Once the vector-based matching is complete, the execution module 214 proceeds with graph-based analysis using the graph database 208b corresponding to the at least one country specified in the user prompt 104. The execution module 214 traverses the nodes and edges of the country-specific knowledge graph to understand how different regulatory requirements relate to one another. By leveraging graph traversal algorithms, the system 110 identifies dependent, overlapping, or conflicting regulatory provisions and determines their relevance to the input document 102.

In one or more embodiments, the system 110 is configured to generate relevant question with associated reasoning, based on the identified regulatory requirements applicable to the input document 102.

In one or more embodiments, each generated question is accompanied by reasoning that explains why the question is necessary in the context of the selected laws. For instance, the reasoning may include references to specific legal provisions, regulatory principles, or compliance obligations that justify the need for verification. The system 110 then presents the generated questions to the user, allowing them to select specific questions for executing the compliance check.

At 408, at least one compliance verification prompt is generated based on vector-based matching and graph-based analysis, and present the at least one compliance verification prompt to a user for selection. The compliance verification prompts are dynamically created to highlight specific regulatory aspects relevant to the AI project, ensuring that compliance verification is targeted and contextually relevant.

In one or more embodiments, the compliance verification prompt is presented to the user via the user interface 106, allowing the user to review and select the most appropriate prompt for further compliance evaluation. This interactive selection process ensures that the compliance verification aligns with the user's intent, regulatory priorities, or specific concerns related to the AI project.

In one or more embodiments, once selected the compliance verification prompt executed by leveraging knowledge graphs and regulatory embeddings for a more precise assessment.

At 410, compliance of the input document 102 is evaluated with respect to the identified regulatory requirements by the evaluation module 216.

In one or more embodiments, evaluating the compliance includes generating requirement-specific compliance scores for each regulatory requirement identified as applicable to the AI project. The evaluation module 216 assesses the alignment between the AI project document and each regulatory requirement by analyzing relevant clauses, their completeness, and any gaps in compliance. The requirement-specific compliance scores may be computed based on semantic similarity, rule-based evaluation, and contextual relevance between the AI project's descriptions and the corresponding regulations.

Furthermore, the evaluation module 216 calculates an overall compliance score for the AI project by aggregating the requirement-specific scores. The overall score may be weighted based on risk levels associated with different regulatory provisions, ensuring that high-risk AI regulations contribute more significantly to the final score.

In one or more embodiments, the evaluation module 216 is configured to calculate compliance scores based on a novel prompt-driven approach utilizing LLM-based reasoning. The compliance assessment involves determining the adherence percentage of the input document 102 to the identified regulatory requirements. Specifically, the evaluation module 216 analyzes various attributes, including the specific regulatory points adhered to and their respective adherence percentages. The entire scoring process leverages LLM-based reasoning, ensuring a more contextual and intelligent evaluation of compliance.

In one or more embodiments, the evaluation module 216 implements a rule engine to identify country-specific laws and regulatory requirements applicable to the input document 102. Once the relevant regulations are identified, the evaluation module 216 utilizes a question generator with reasoning to formulate a set of contextually relevant questions that assess the document's compliance with the identified laws. The generated questions serve as compliance checkpoints, ensuring a structured and thorough verification process.

At 412, the output module 218 outputs a compliance report comprising a compliance status and remediation recommendations for non-compliant regulatory requirements. The compliance report provides a structured overview, categorizing the regulatory requirements as compliant, non-compliant, or partially compliant, and includes explanations for each categorization.

In one or more embodiments, the remediation recommendations generated by the output module 218 include specific and actionable modifications to address non-compliant regulatory requirements. The recommendations may involve adjustments in policies, documentation refinements, or technical changes necessary for alignment with applicable AI regulations.

In one or more embodiments, the output module 218 is configured to generate recommendations for non-compliant regulatory requirements, along with an overall compliance health score. The recommendations provide specific actions required to achieve compliance, ensuring that the input document 102 aligns with the identified country-specific AI laws.

The method and system presented in the disclosure offer significant advantages over existing AI compliance verification solutions by providing an automated, scalable, and intelligent approach. The system is designed as a plug-and-play framework that can seamlessly support different types of AI documents and accommodate compliance verification for multiple country-specific AI laws. This adaptability allows organizations to verify compliance across different regulatory landscapes without requiring extensive manual configuration.

The system is technically advanced by incorporating an intelligent rule engine that is capable of dynamically matching the rules between an input document and the relevant country-specific AI Act laws. Users can specify the specific sections of the document for compliance verification, and the system automatically executes the compliance check, generating detailed compliance reports without requiring extensive manual effort, which is not addressed by any of the existing solutions.

Moreover, in cases where users are unsure about which rules apply to a given input document, the system enables full-document uploads. Using a rule matching engine which integrates RAG with a Graph DB, the system automatically generates relevant compliance-related questions along with reasoning, ensuring that all applicable regulations are considered.

A key innovation and advancement in the present system is its ability to enhance user prompts using a graph database entity-based approach. This feature allows users to select from multiple compliance-related prompts, helping them explore AI law knowledge in greater depth through a Q&A bot. The guided prompt enhancement ensures more accurate and relevant compliance verification.

Unlike conventional systems that merely highlight compliance violations, the disclosed method and system go a step further by generating actionable recommendations. These recommendations outline specific modifications needed to confirm that the document complies with country-specific AI laws, making the compliance process proactive rather than just reactive.

The system is well advanced, and it significantly reduces or even eliminates the need for manual compliance verification. By leveraging a combination of vector-based search, knowledge graphs, and rule-based automation, the system ensures that compliance verification is conducted efficiently, accurately, and at scale minimizing human errors and resource costs.

Another key advantage of the disclosed method and system is the persistence of chronological compliance status, which enables AI developers to track compliance across different stages of the software development lifecycle, including requirements analysis, design, coding, and deployment.

Moreover, the system comprises the technical capability to generate compliance trend reports, enabling organizations to analyze how their AI models evolve in relation to regulatory standards over time. This capability not only improves regulatory transparency but also helps in audit readiness by maintaining a structured history of compliance verification efforts.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for automated compliance verification of artificial intelligence (AI) projects, comprising:
a processor;
a memory storing instructions that, when executed, cause the processor to:
maintain a hybrid knowledgebase comprising a vector store containing embedding vectors generated from a plurality of AI regulatory documents corresponding to a plurality of countries, and a graph database storing country-specific knowledge graphs, wherein each knowledge graph represents relationships between AI regulatory requirements for a corresponding country;
receive an input document corresponding to an AI project, and a user prompt specifying at least one country for compliance verification;
generate embedding vectors for the input document;
execute, via a rule engine:
vector-based matching between embedding vectors of the input document and the vector store;
graph-based analysis using knowledge graphs corresponding to the at least one country to identify regulatory requirements applicable to the input document;
evaluate compliance of the input document with respect to the identified regulatory requirements; and
output a compliance report comprising a compliance status and remediation recommendations for non-compliant regulatory requirements.

2. The system of claim 1, wherein the vector store containing embedding vectors is generated by:
segmenting the plurality of AI regulatory documents into a plurality of text chunks;
generating embedding vectors for the plurality of text chunks; and
storing the embedding vectors along with corresponding metadata.

3. The system of claim 1, wherein the knowledge graph for each country comprises:
nodes representing regulatory requirements; and
edges representing relationships between the regulatory requirements.

4. The system of claim 1, wherein the instructions further cause the processor to update the hybrid knowledgebase by incorporating new regulatory requirements and relationships from updated AI regulatory documents.

5. The system of claim 1, wherein the instructions further cause the processor to:
extract entities from the input document; and
identify related entities from the knowledge graphs corresponding to the at least one country.

6. The system of claim 1, wherein the user prompt comprises a selection of specific portions of the input document for compliance verification.

7. The system of claim 1, wherein the instructions further cause the processor to:
generate at least one compliance verification prompt based on the vector-based matching and graph-based analysis;
present the at least one compliance verification prompt to a user interface for selection; and
execute compliance verification using a selected compliance verification prompt.

8. The system of claim 1, wherein the instructions further cause the processor to:
generate relevant questions with associated reasoning, based on the identified regulatory requirements applicable to the input document.

9. The system of claim 1, wherein evaluating compliance comprises:
generating requirement-specific compliance scores for the regulatory requirements; and
calculating an overall compliance score based on the requirement-specific scores.

10. The system of claim 1, wherein the remediation recommendations comprise specific modifications to achieve compliance with the non-compliant regulatory requirements.

11. A method for automated compliance verification of artificial intelligence (AI) projects, comprising:
maintaining a hybrid knowledgebase comprising a vector store containing embedding vectors generated from a plurality of AI regulatory documents corresponding to a plurality of countries, and a graph database storing country-specific knowledge graphs, wherein each knowledge graph represents relationships between AI regulatory requirements for a corresponding country;
receiving an input document corresponding to an AI project, and a user prompt specifying at least one country for compliance verification;
generating embedding vectors for the input document;
executing, via a rule engine:
vector-based matching between the generated embedding vectors and the vector store;
graph-based analysis using knowledge graphs corresponding to the at least one country to identify regulatory requirements applicable to the input document;
evaluating compliance of the input document with respect to the identified regulatory requirements; and
outputting a compliance report comprising a compliance status and remediation recommendations for non-compliant regulatory requirements.

12. The method of claim 11, wherein maintaining the vector store comprises:
segmenting the plurality of AI regulatory documents into a plurality of text chunks;
generating embedding vectors for the plurality of text chunks; and
storing the generated embedding vectors along with corresponding metadata.

13. The method of claim 11, further comprising updating the hybrid knowledgebase by incorporating new regulatory requirements and relationships from updated AI regulatory documents.

14. The method of claim 11, further comprising:
extracting entities from the input document; and
identifying related entities from the knowledge graphs corresponding to the at least one country.

15. The method of claim 11, wherein the user prompt comprises a selection of specific portions of the input document for compliance verification.

16. The method of claim 11, further comprising:
generating multiple compliance verification prompts based on the vector-based matching and graph-based analysis;
presenting the generated compliance verification prompts via a user interface; and
executing compliance verification using a selected compliance verification prompt.

17. The method of claim 11, further comprising:
generating relevant questions with associated reasoning, based on the identified regulatory requirements applicable to the input document.

18. The method of claim 11, wherein evaluating compliance comprises:
generating requirement-specific compliance scores for the identified regulatory requirements; and
calculating an overall compliance score based on the requirement-specific compliance scores.

19. The method of claim 11, wherein the remediation recommendations comprise specific modifications to portions of the input document to achieve compliance with the non-compliant regulatory requirements.
